(19) United States
(12) Patent Application Publication
(10) Pub. No.: US 2026/0179349 A1
(43) Pub. Date: Jun. 25, 2026

(54) ARTIFICIAL INTELLIGENCE SYSTEMS FOR MULTI-GOLDEN SAMPLE INSPECTIONS

(71) Applicant: NVIDIA Corporation, Santa Clara, CA (US)

(72) Inventors: Parthasarathy Sriram, Los Altos Hills, CA (US); Varun Praveen, Cupertino, CA (US); Zaid Pervaiz Bhat, Sunnyvale, CA (US); Hung-Jen Chen, Hsinchu City (TW); Yan-Yang Ji, Taipei City (TW); Guan-Hong Liou, Taoyuan City (TW); Yu-Chien Huang, Hsinchu City (TW); Vidya Nariyambut Murali, Sunnyvale, CA (US)

(21) Appl. No.: 19/000,394

(22) Filed: Dec. 23, 2024

(51) Int. Cl. G06V 10/44; G06V 10/764; G06V 10/82

(52) U.S. Cl. CPC G06V 10/44; G06V 10/764; G06V 10/82

(57) ABSTRACT

In various examples, systems and techniques are provided that are directed to training and deployment of multi-golden sample inspection systems. The disclosed techniques include processing, using a backbone neural network, an image of a sample to generate a sample feature representative of the sample and obtaining reference features representative of reference images. The disclosed techniques further include generating differential features representative of differences between the sample feature and the reference features and predicting characteristics of the sample based on aggregated differential features.

### TECHNICAL FIELD

At least one embodiment pertains to processing resources used to perform and facilitate artificial intelligence (AI). For example, at least one embodiment pertains to operations encountered in training and using machine learning models for efficient data processing and inspection, according to various novel techniques described herein.

### BACKGROUND

Machine learning is often applied to image processing, such as identification of objects depicted within images. Object identification is used in medical imaging, science research, autonomous driving systems, robotic automation, security applications, law enforcement practices, and many other settings. Machine learning involves training a computing system using training images and other training data—to identify patterns in images that may facilitate object identification. Training can be supervised or unsupervised. Machine learning models can use various computational algorithms, such as decision tree algorithms (or other rule-based algorithms), artificial neural networks, and the like. During the inference stage, a new image is input into a trained machine learning model and various target objects of interest (e.g., vehicles in an image of a roadway) can be identified using patterns and features identified during training.

### BRIEF DESCRIPTION OF DRAWINGS

FIG. 1 is a block diagram of an example computer system that is capable of training and deploying high accuracy multi-golden sample inspection (MGSI) systems, according to at least one embodiment;

FIG. 2 is an example computing device that may support operations of MGSI systems, according to at least one embodiment;

FIG. 3A illustrates example operations of a MGSI system performed for high-accuracy inference of test data, according to at least one embodiment;

FIG. 3B illustrates an example architecture of a backbone network that may be deployed to perform the operations of FIG. 3A, according to at least one embodiment;

FIG. 4 illustrates example operations of training the MGSI system of FIG. 3A, according to at least one embodiment;

FIG. 5 is a flow diagram of an example method of deployment of an MGSI system for inference of sample data, according to at least one embodiment;

FIG. 6 is a flow diagram of an example method of training an MGSI system, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment.

### DETAILED DESCRIPTION

Computer vision AI systems are used for manufacturing quality control, among other

applications. A manufacturing line or process can make products, e.g., wafers, dies, integrated circuits, printed circuit boards, and/or the like. Various products (also referred to as samples herein) can undergo a suitable inspection, e.g., optical inspection, scanning electron microscopy inspection, x-ray inspection, and/or the like, to evaluate quality of the products and determine compliance of products with specifications of a manufacturing process. Inspections can be performed on each product, on periodically selected products, on randomly selected products, and/or the like. Some inspection techniques can include using a trained AI model to process the image and generate an output, e.g., a binary prediction of whether the image depicts a product that meets manufacturing goals.

In golden sample inspections, an image of a sample is compared to a “golden sample” image of a high-quality product. The quality of the sample is inferred from how closely the image of the sample resembles the golden sample image. Such inference can be performed by an AI model that processes the sample image and the golden sample image individually by a backbone neural network that generates features (feature vectors, embeddings) representative of each image and a classifier network that compares the similarity between the generated features and predicts whether the sample has an acceptable quality. Golden sample techniques are capable of successfully identifying high-quality samples but often result in a substantial number of false negatives by flagging samples of acceptable quality yet somewhat dissimilar from the golden sample image causing the model to incorrectly classify the sample as a poor-quality sample.

Aspects and embodiments of the present disclosure address these and other technological challenges of golden sample testing technology by providing for high accuracy multi-golden sample inspection (MGSI) systems and techniques. In some embodiments, an ensemble of multiple, e.g., N, golden samples may be acquired representative of a range of variations (or a distribution) of acceptable products of a manufacturing process or some other technological process. Such an ensemble may indicate a range of tolerances of manufacturing products that are acceptable for intended purposes. A sample whose image is similar to some or any of the golden samples of the ensemble may represent a product of a sufficient quality. Images of a sample being tested (the testing sample) and N golden samples may be processed by N+1 parallel instances of a backbone network (or sequentially using a single instance of the backbone network applied N+1 times) and N+1 respective sets of features may be generated, e.g., vectors in a reduced-dimensionality space with a number of dimensions D that is sufficient to capture visual appearance of the images of interest. In some embodiments, e.g., in situations where a stream of numerous testing samples is being inspected by comparing to a fixed set of golden samples, backbone processing of N golden sample images need not be performed during live testing. Instead, features of N golden samples may be precomputed and stored in a memory of the MGSI system, and a single instance of the backbone network may process the image of the testing sample. The N+1 generated features can then be processed by N instances of a differentiator network (in parallel or sequentially) to generate N differential features representative of differences between the features of the testing sample and the respective features of the golden samples. The N differential features may next be processed by an aggregator that combines the differential features into an aggregated feature jointly representing both the testing sample and the N golden samples. In some embodiments, the aggregator may compute an average of all input differential features. In some embodiments, the aggregator may concatenate and process the input differential features using one or more neural network layers (e.g., fully-connected or linear layers). In some embodiments, the aggregator may include one or more transformer blocks that perform attention processing of the differential features, e.g., by treating various differential features as attention queries and various other differential features and keys and values. An output of the aggregator—an aggregated feature—may be processed by a final classification head that outputs a prediction for the sample. The prediction can include a probability P (e.g., generated by a sigmoid layer of the classification head) that the sample' has a sufficient quality (with the corresponding probability 1−P that the sample's quality is insufficient). In some embodiments, the classification head may generate multiple probabilities Pᵢ (e.g., generated by a softmax layer) that the testing sample complies with a corresponding number of testing categories, e.g., critical dimensions, purity, chemical composition, and/or the like. In some embodiments, the disclosed MGSI systems may be trained end-to-end, with the backbone network, differentiator network, aggregator (if implemented as a neural network), and the classification network trained together, e.g., using a suitable loss function and concurrent error backpropagation through various layers of the networks.

The advantages of the disclosed systems and techniques include but are not limited to more accurate detection of samples having sufficient (or, conversely, insufficient) quality and the ensuing significant reduction of instances of false negative inspection results. Additionally, the disclosed techniques alleviate the need for a labor-intensive selection of a single golden sample and the subsequent extensive training of a detector model to learn various acceptable departures from that golden sample and instead enable the use of a set of less-than-perfect samples obtained in the course of normal manufacturing and selected by a process engineer with minimal effort. Although throughout this disclosure various concepts are illustrated with reference to examples of images, substantially the same or similar concepts can be used with analysis of data of various other types, e.g., audio data, sensor data (e.g., temperature data, pressure data, optical reflectivity data, chemical composition data, and/or the like), traffic data, security data, public and private safety data, financial data, as well as various other types of data encountered in many practical applications.

### System Architecture

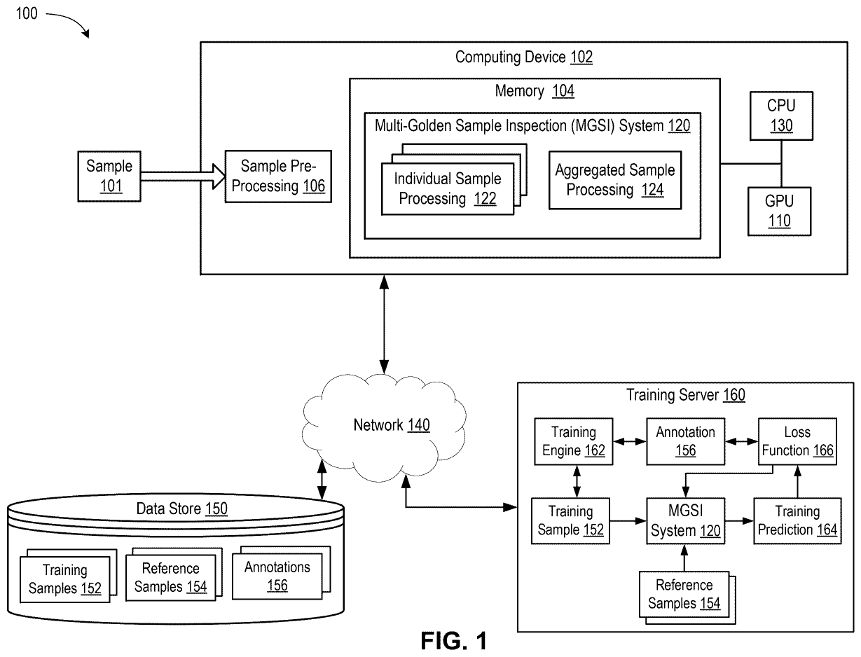

FIG. 1 is a block diagram of an example computer system 100 that is capable of training and deploying high accuracy multi-golden sample inspection (MGSI) systems, in accordance with at least some embodiments. As depicted in FIG. 1, a computing system 100 may include a computing device 102, a data store 150, and a training server 160 connected to a network 140. Network 140 may be a public network (e.g., the Internet), a private network (e.g., a local area network (LAN), or wide area network (WAN)), a wireless network, a personal area network (PAN), a combination thereof, and/or another network type.

Computing device 102 may be a desktop computer, a laptop computer, a smartphone, a tablet computer, a server, or any suitable computing device capable of performing the techniques described herein. Computing device 102 may may be configured to receive a sample 101, e.g., through any suitable input/output interface. In some embodiments, sample 101 may include one or more images. In the description below, for conciseness, “sample” is used to indicate both a physical object being examined and any suitable data (e.g., image, sensor data, audio data, etc.) depicting, describing, and/or characterizing the physical object. In some embodiments, the image(s) or other data may be generated by one or more devices connected to the computing device 102. For example, devices capable of generating sample 101 may include photographic equipment, scanners, video cameras, optical inspection devices (including photodetectors, reflectometers, ellipsometers, and/or the like), scanning electron microscopes, tunneling electron microscopes, atomic force microscopes, x-ray electron spectroscopy devices, autonomous vehicle sensors (e.g., lidars, radars, long-and mid-range cameras, infrared cameras, etc.), and the like. In some embodiments, sample 101 may include an image of a wafer (substrate), one or more dies, integrated circuits, printed circuit boards, and/or any image of other products and/or objects. Sample 101 may be in any digital (e.g., pixel-based or vector-based) format, including but not limited to JPEG, GIF, PNG, BMP, TIFF, CIB, DIMAP, NITF, and so on. Sample 101 may be stored (e.g., together with other samples or data) in data store 150. Additionally, data store 150 may store training samples 152 for training of one or more neural networks (or other models) of multi-golden sample inspection systems, according to some embodiments disclosed herein. Data store 150 can be accessed by computing device 102 directly or (as shown) indirectly via network 140.

Data store 150 may be a persistent storage capable of storing images as well as metadata for the stored images. Data store 150 may be hosted by one or more storage devices, such as main memory, magnetic or optical storage devices, disks, tapes or hard drives, network attached storages (NAS), storage area networks (SAN), and so forth. Although depicted as separate from computing device 102, in at least one embodiment data store 150 may be a part of computing device 102. In at least some embodiments, data store 150 may be a network-attached file server, while in other embodiments data store 150 may be some other type of persistent storage such as an object-oriented database, a relational database, and so forth, that may be hosted by a server machine or one or more different machines coupled to the computing device 102 via network 140.

Computing device 102 may intake sample 101 and perform any suitable sample preprocessing 106, which may include trimming, sharpening, blur, noise or other artifact removal, compression, resampling, normalizing, upsampling, or other operations, or any combination thereof.

Computing device 102 may include a memory 104 communicatively coupled to one or more processing devices, such as one or more graphics processing units (GPU) 110, one or more central processing units (CPU) 130, one or more parallel processing units (PPUs) or accelerators, such as a deep learning accelerator, data processing units (DPUs), and/or the like. Memory 104 may store one or more models of the MGSI system 120, including various models that implement individual sample processing 122 (e.g., backbone networks, differentiator networks, and/or the like) and aggregated sample processing 124 (e.g., aggregator, classification head, and/or the like). MGSI system 120 may be executed by GPU 110, CPU 130, PPUs, DPUs, and/or the like. MGSI system 120 may use sample 101 (or training sample 152) as input to predict one or more characteristics of sample 101, e.g., overall sample quality, various critical dimensions, chemical purity, chemical composition, and/or the like. In at least one embodiment, MGSI system 120 may operate in conjunction with a manufacturing system (e.g., machine, line, process, and/or the like). Based on predicted sample characteristics, the manufacturing system may be stopped, adjusted, tuned, and/or otherwise modified to improve sample quality or ensure that the samples produced by the manufacturing system conform to any applicable specification of a manufacturing process implemented thereon.

Various networks and/or components of MGSI system 120 may be trained by a training server 160. In at least one embodiment, training server 160 may be a part of computing device 102. In other embodiments, training server 160 may be communicatively coupled to computing device 102 directly or indirectly via network 140. Training server 160 may be (or include) a rackmount server, a router computer, a desktop computer, a laptop computer, a smartphone, a tablet computer, a server, a media center, and/or any suitable computing device or combination thereof capable of performing the techniques described herein. Training server 160 may include a training engine 162. In at least one embodiment, training engine 162 may initiate and train one or more machine learning models (e.g., neural networks of MGSI system 120).

Training (updating) of MGSI system 120 may be performed using training data stored in data store 150. Training data may include training samples 152, reference samples 154, and annotations 156, e.g., ground truth assessments of training samples 152. Reference samples 154 may be (or include) golden samples indicative of acceptable variations in samples that undergo the inspection. Annotations 156 may indicate whether training samples 152 are sufficiently similar to one or more reference samples 154 (and, therefore, represent acceptable product variations) or are substantially different from any of the reference samples 154 (and, therefore, unacceptably depart from target specifications). In some embodiments, various networks and models of MGSI system 120 may be trained together, e.g., end-to-end, with errors in the final predictions backpropagated through multiple networks, e.g., backbone network(s), differentiator network(s), aggregator network, classification head, and/or the like.

In at least one embodiment, various networks and models of MGSI system 120 may be implemented as deep learning neural networks having multiple levels of linear or non-linear operations. For example, each or some of the networks and models of MGSI system 120 may include convolutional neural networks, recurrent neural networks (RNN), fully connected neural networks, attention-based neural networks, transformer neural networks, vision transformer neural networks, and/or the like. In at least one embodiment, each or some of the networks and models of MGSI system 120 may include multiple neurons with each neuron receiving its input from other neurons or from an external source and may produce an output by applying an activation function to the (trainable) weighted sum of inputs and a bias value. In at least one embodiment, each or some of the networks and models of MGSI system 120 may include multiple neurons arranged in layers, including an input layer, one or more hidden layers, and an output layer. Neurons from adjacent layers may be connected by weighted edges. Initially, edge weights may be assigned some starting (e.g., random) values.

Training of MGSI system 120 may be performed by the training engine 162 selecting a training sample 152 and a corresponding set of two or more reference samples 154. Training sample 152 and reference samples 154 may be processed by various networks of MGSI system 120 being trained to generate a training prediction 164 for training sample 152. In some embodiments, training prediction 164 may be a single binary prediction, e.g., “satisfactory sample” or “unsatisfactory sample.” In some embodiments, training prediction 164 may include a set of binary predictions, e.g., “layout satisfactory/unsatisfactory,” “dimensions satisfactory/unsatisfactory,” “chemical composition satisfactory/unsatisfactory,” “purity satisfactory/unsatisfactory,” and/or the like. In some embodiments, training prediction 164 may include a set of non-binary predictions, e.g., “overall quality: 0, 1, . . . , or M,” “layout accuracy: 0, 1, . . . , or N,” and/or the like. In some embodiments, training prediction 164 may include continuous probabilities, e.g., defined within the interval of values [0,1] representing a likelihood that training sample 152 has adequate quality (and/or similarly for other characteristics of the sample). Training prediction 164 may be compared with an annotation 156 (ground truth, desired target output) using a suitable loss function 166 and the difference between the training prediction 164 and annotation 156 may be backpropagated through networks of MGSI system 120 changing various network parameters (e.g., weights and biases of individual neurons) to bring training prediction(s) 164 closer to annotation(s) 156. This adjustment may be repeated until the output error for a given training sample 152 satisfies a predetermined condition (e.g., falls below a predetermined value). Subsequently, a different training sample 152 may be selected, a new output generated, and a new series of adjustments implemented, until the respective neural networks are trained to an acceptable degree of accuracy or a maximum accuracy achievable given the networks'architecture and complexity (e.g., a number of neurons/layers of the models, etc.).

Such learning techniques train MGSI system 120 to identify patterns in training samples 152 based on desired target outputs. Predictive utility of the identified patterns may be subsequently verified using additional training samples/annotations and then used, during the inference stage in future processing of new (previously unencountered) samples.

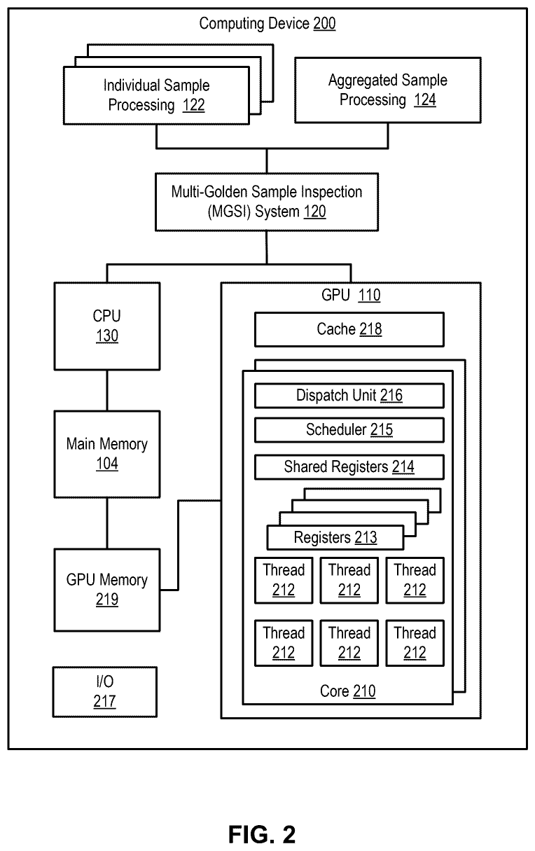

FIG. 2 is an example computing device 200 that may support operations of high accuracy multi-golden sample inspection systems, according to at least one embodiment. In some embodiments, computing device 200 may be (or include) computing device 102 of FIG. 1, a computing device of training server 160, and/or any other applicable computing device performing operation of the instant disclosure. Operations of MGSI system 120, and/or various modules operating in conjunction with MGSI system 120, e.g., individual sample processing 122, aggregated sample processing 124, and/or other software/firmware instantiated on computing device 200 may be executed using one or more GPUs 110, CPUs 130, PPUs, DPUs, and/or the like. In at least one embodiment, a GPU 110 includes multiple cores 210. An individual core 210 may be capable of executing multiple threads 212. Individual cores 210 may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of a core 210. In at least one embodiment, individual cores 210 may include a scheduler 215 to distribute computational tasks and processes among different threads 212 of the core. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 110 may have a (high-speed) cache 218, access to which may be shared by multiple cores 210. Furthermore, computing device 200 may include a GPU memory 219 where GPU 110 may store intermediate and/or final results (outputs) of various computations performed by GPU 110. After completion of a particular task, GPU 110 (or CPU 130) may move the output to (main) memory 104. In at least one embodiment, CPU 130 may execute processes that involve serial computational tasks whereas GPU 110 may execute tasks (such as multiplication of inputs of a neural node by weights and adding biases) that are amenable to parallel processing.

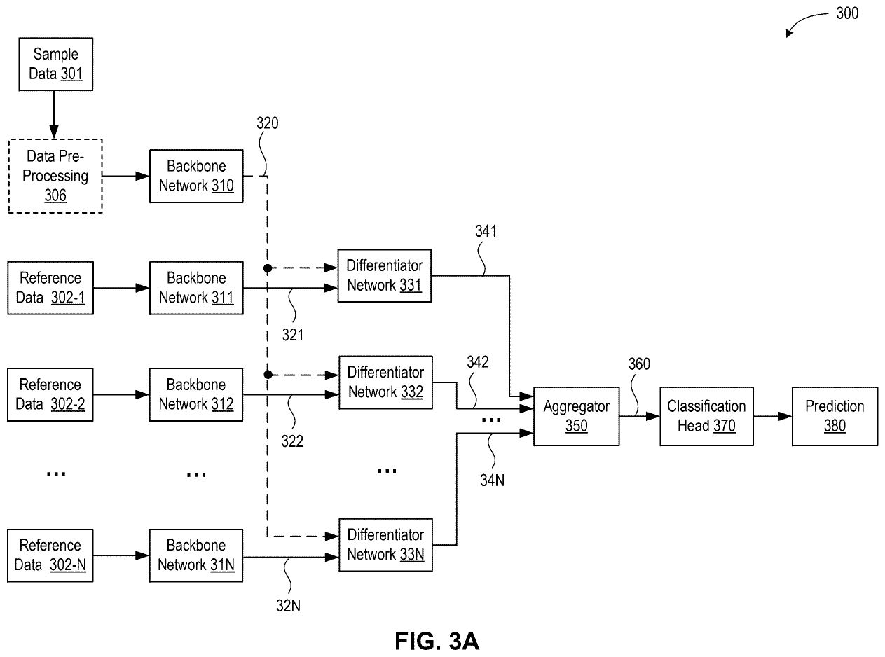

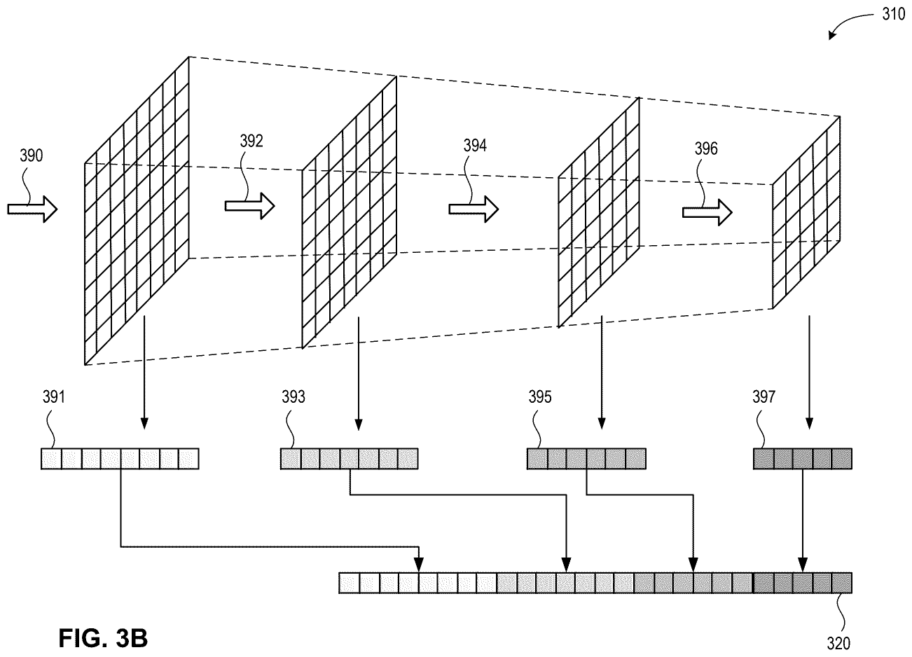

FIG. 3A illustrates example operations 300 of a multi-golden sample inspection system performed for high-accuracy inference of test data, according to at least one embodiment. In at least one embodiment, operations 300 may be performed by MGSI system 120 of computing device 102 of FIG. 1 or computing device 200 of FIG. 2. As depicted in FIG. 3A, operations 300 may be performed on sample data 301, which may include an image of a sample (e.g., sample 101 in FIG. 1), audio data, data collected by one or more physical sensors and/or one or more chemical sensors (including any applicable time series of data), and/or data collected by any other measurement devices, and/or a combination thereof. Sample data 301 may be representative of characteristics of any product or process, including but not limited to a manufacturing product (e.g., a semiconductor device, such as a chip with transistors and interconnect circuitry). Sample data 301 may be representative of characteristics of a final product or any intermediate product that is still to undergo at least some additional processing stages. For example, an intermediate product may include a bare wafer, a wafer with one or more films deposited thereon, a wafer that has undergone plasma etching, atomic layer deposition, mask deposition, beam epitaxy, and/or any other manufacturing operations.

In one example, sample data 301 may include a two-dimensional Iₖ(x, y) or a three-dimensional Iₖ(x, y, z) having one (e.g., black-and-white) or more (e.g., color) intensity values Iₖ for a plurality pixels or of voxels identified with coordinates x, y or x, y, z. Intensity may be measured in any appropriate units, e.g., in the limited range extending from 0 to 1 (0 to 100, or in any other limited range), with I=0 corresponding to dark (e.g., black) pixels/voxels and I=1 corresponding to bright (e.g., white) pixels/voxels. In at least one embodiment, intensity values may be obtained for different instances of time (e.g., a times series of images, such as video frames). In another example, sample data 301 may include a time series or audio frames or audio spectrograms of an audio recording. In some embodiments, sample data 301 may undergo data preprocessing 306, which

may include trimming data, denoising data (e.g., image sharpening, blur, or other artifact removal), compressing data, resampling data, normalizing data, upsampling data, batching data, or performing any other suitable operations on sample data 301, and/or any combination thereof.

Sample data 301 may be used in conjunction with N sets of reference data 302-1, 302-2, . . . 302-N, which may include golden samples for a particular product or process associated with sample data 301. Reference data 302-n may be of the same type (e.g., images) as sample data 301. Reference data 302-n may be representative of a distribution of acceptable variations for sample data 301, e.g., depicting different products of a manufacturing process that are determined (e.g., by a process engineer) to be of a sufficient quality. The ensemble of reference data 302-1, 302-2, . . . 302-N may indicate a range of tolerances of manufacturing products acceptable for intended purposes without explicitly enumerating bounds of various features, characteristics, and/or dimensions of the products. Sample data 301 that is similar to one or more of the reference data 302-n may represent a product of an acceptable quality.

Sample data 301 (which may be suitably preprocessed and digitized) may be processed by an instance of a backbone network, e.g., backbone network 310. In some embodiments, backbone network 310 may be (or include) a convolutional neural network (CNN), a transformer neural network, a conformer (a combination of a CNN and transformer) neural network, and/or some other suitable neural network. Backbone network 310 may transform sample data 301 into a sample feature 320, which may also be referred to as a feature vector or embedding. A feature (feature vector, embedding) should be understood as any suitable digital representation of an input data (e.g., sample data 301) via a vector (set) of any number D components, which can have integer values or floating-point values. Features (e.g., sample feature 320) may be considered as vectors or points in a D-dimensional feature space with the dimensionality D of the features space smaller than the size of the input data and defined as part of a model (e.g., backbone network 310) architecture. During training, the model learns to associate similar sets of input data with similar features represented by points closely situated in the feature space and associate dissimilar sets of input data with points that are located further apart in the feature space.

As illustrated in FIG. 3A, additional backbone networks 311, 312, . . . 31N may process respective reference data 302-1, 302-2, . . . 302-N and generate reference features 321, 322, . . . 32N. In some embodiments, N+1 backbone networks 310, 311, 312, . . . 31N may be processing the input data in parallel. In some embodiments, the backbone networks 310, 311, 312, . . . 31N may include the same neural network operations performed by separate processing threads of a processing device (e.g., GPU) or multiple processing devices, e.g., using a shared memory device or different memory devices. In some embodiments, a single instance of a backbone network may sequentially perform illustrated operations of N+1 backbone networks 310, 311, 312, . . . 31N. In some embodiments, N reference features 321, 322, . . . 32N may be precomputed and stored in a system memory (e.g., memory 104 of computing device 102 in FIG. 1). In such embodiments, a single backbone network 310 may process sample data 301 and generate sample feature 320 while reference features 321, 322, . . . 32N may be fetched from the system memory.

The N+1 generated features may be processed by N instances of a differentiator network. More specifically, a differentiator network 331 may process sample feature 320 and reference feature 321 generated by backbone network 310. Similarly, differentiator networks 332 . . . 33N may process a copy of sample feature 320 and reference features 322 . . . 32N (generated by respective backbone networks 312 . . . 31N). Differentiator networks 331, 332, . . . 33N may generate N differential features 341, 342, . . . 34N. Differential features 34n may represent (encode) differences between respective reference features 32n and the sample feature 320. In some embodiments, differentiator networks 331, 332, . . . 33N may be the same and may include one or more learned neuron layers (e.g., fully-connected or linear layers). In some embodiments, differential features 341, 342, . . . 34N may have the same dimension D as the sample/reference features. In some embodiments, the dimension of the differential features may be different. In some embodiments, N instances of the differentiator networks 33n may be used in parallel (e.g., for faster processing). In some embodiments, a single instance of the differentiator networks may process different pairs of input sequentially, one after another (e.g., for less resource-intensive processing). The N differential features 341, 342, . . . 34N may be processed by an aggregator 350 that combines the differential features into an aggregated feature 360 that jointly represents sample data 301 and N reference data 302-1 . . . 302-N. In some embodiments, aggregator 350 may be a hard-coded function, e.g., an average of N differential features 341, 342, . . . 34N. In some embodiments, aggregator 350 may concatenate and process N differential features 341, 342, . . . 34N using one or more neural network layers (e.g., fully-connected or linear layers). In some embodiments, aggregator 350 may include one or more transformer blocks that apply attention processing to the differential features. For example, during a round of processing, differential feature 341 may be used as an attention query and other differential features 342 . . . 34N may be used as keys and values. (More specifically, various query-key scalar products may be computed and used to determine weights with which the respective values are combined into a hidden state for the specific query.) During another round of processing, differential feature 342 may be used as an attention query and other differential features 341, 342, . . . 34N may be used as keys and values, and so on. (In some embodiments, when a given differential feature 34n is used as a query, the same differential feature 34n may also be used as one of the key-values.)

An aggregated feature 360 produced by aggregator 350 may be processed by a classification head 370 that outputs a prediction 380 for the sample. Prediction 380 can include a probability P (or a log-probability), which may be generated by a final sigmoid layer of classification head 370, that the sample has a sufficient quality. The value 1−P may represent the probability that the sample's quality is insufficient. In some embodiments, classification head 370 may generate multiple probabilities Pᵢ, e.g., generated by a final softmax layer of classification head 370. Different probabilities Pᵢ may indicate whether the sample complies with the corresponding number of testing categories, e.g., overall quality (i=1), critical dimensions (i=2), purity (i=3), chemical composition (i=4), and/or the like.

FIG. 3B illustrates an example architecture of backbone network 310 that may be deployed to perform operations 300 of FIG. 3A, according to at least one embodiment. FIG. 3B depicts a portion of backbone network 310 that includes processing stages 390, 392, 394, and 396 of a gradually decreasing resolution (expanding field of view with intermediate features representing progressively increasing number of pixels/voxels). The arrows indicate schematically the respective processing stages. Individual processing stages may apply one or more layers of neurons and may generate intermediate features aggregated (e.g., concatenated, averaged, weight-averaged, and/or the like) to produce a sample feature 320. For example, processing stage 390 may generate intermediate feature 391, processing stage 392 may generate intermediate feature 393, processing stage 394 may generate intermediate feature 395, processing stage 396 may generate intermediate feature 397, and/or the like. Intermediate features 391, 393, 395, and 397 (in addition to being used as input into subsequent processing stages) may be aggregated into sample feature 320. The number of processing stages whose intermediate features are aggregated into sample feature 320, e.g., one, two, four, etc., may be determined empirically, e.g., during training of the backbone network. Although operations of a backbone network is illustrated in FIG. 1 using the example of backbone network 310 (which processes sample data 301 and generates sample feature 320), substantially the same or similar processing and feature aggregation may be used in processing of reference data 302-1 . . . 302-N by backbone networks 311 . . . 31N to generate respective reference features 321 . . . 32N.

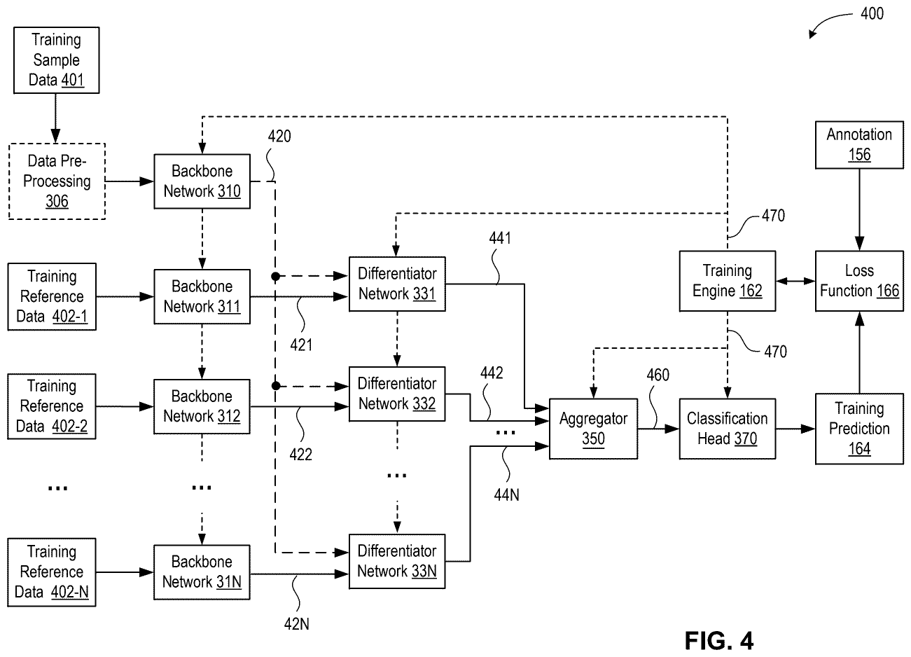

FIG. 4 illustrates example operations 400 of training the multi-golden sample inspection system of FIG. 3A, according to at least one embodiment. In at least one embodiment, operations 400 may be used to train the MGSI system responsive to instructions from training engine 162 (also illustrated in FIG. 1). In particular, training engine 162 may select a training sample data 401 and a set of multiple training reference data 402-n. As depicted in FIG. 4, operations 400 may be performed on training sample data 401, which may be of the same type (e.g., image, audio data, sensor data, etc.) as sample data 301 that the MGSI system is process during inference operations illustrated in FIG. 3A. In some embodiments, training sample data 401 may undergo a similar data preprocessing 306 as undergone by sample data 301 during inference operations, including data trimming, denoising, sharpening, artifact removal, compression, normalizing, upsampling or downsampling, and/or the like.

Training sample data 401 may be used in conjunction with N sets of training reference data 402-1, 402-2, . . . 402-N, e.g., golden samples for various product or processes associated with training sample data 401. In some embodiments, any, some, or all training reference data 402-1, 402-2, . . . 402-N may (but does not have to) be the same (or similar) as reference data 302-1, 302-2, . . . 302-N used during inference operations. In some embodiments, training reference data 402-1, 402-2, . . . 402-N may be different from reference data 302-1, 302-2, . . . 302-N) used during inference operations. In some embodiments, training sample data 401 may undergo preprocessing 306 that is different from preprocessing of training reference 402-1, 402-2, . . . 402-N.

Training sample data 401 and training reference data 402-n (each suitably preprocessed and digitized, if applicable) may be processed (in parallel, sequentially, or some combination thereof) by respective instances of backbone network 310, 311, . . . 31N to generate training sample feature 420 and training reference features 421, . . . 42N. These generated features may be processed by N instances of the differentiator network 331 . . . 33N and generate N training differential features 441, 442, . . . 44N that digitally encode differences between respective training reference features 42n and the training sample feature 420. The N training differential features 441, 442, . . . 44N may be processed by an aggregator 350 (a hard-coded algorithm or a trainable neural network) to produce a training aggregated feature 460 that jointly represents training sample data 401 and N instances of training reference data 402-1 . . . 402-N.

Training aggregated feature 460 produced by aggregator 350 may be processed by classification head 370 that outputs a training prediction 164 for the training sample data 401. In some embodiments, training prediction 164 may be a single binary prediction, e.g., “satisfactory sample” or “unsatisfactory sample.” In some embodiments, training prediction 164 may include a continuous probability, P, e.g., defined on the interval of values [0,1], or the log probability log P, e.g., defined on the interval of values (−∞, +∞), predicting a satisfactory or unsatisfactory sample quality. In some embodiments, training prediction 164 may include a set of multiple binary predictions, e.g., “layout satisfactory/unsatisfactory,” “dimensions satisfactory/unsatisfactory,” “chemical composition satisfactory/unsatisfactory,” “purity satisfactory/unsatisfactory,” and/or the like. In some embodiments, training prediction 164 may include a set of multiple continuous probabilities {Pᵢ} or log-probabilities {log Pᵢ} representing respective likelihood(s) that a training sample depicted in training sample data 401 complies with the above (or any other number of) testing categories. In some embodiments, training prediction 164 may be compared with a (ground truth) annotation 156 using a suitable loss function 166. Annotation 156 may include any assessment of training sample data 401, e.g., as may be made by a process or product engineer, including classification of the training sample over one or more classes. Loss function 166 may be (or include) the binary cross-entropy loss function, the Kullback-Leibler loss function, and/or some other suitable loss function. Loss function 166 may use the training prediction 164 and annotation 156 as inputs (arguments) and output a loss value 470 that quantifies the difference between the inputs. As illustrated schematically with the dashed arrow in FIG. 4, loss value 470 may be backpropagated through one or more networks of the MGSI system with various network parameters (e.g., weights and biases of individual neurons) of the networks modified using various techniques of backpropagation, stochastic gradient descent, and/or the like to bring training prediction 164 aligned with (closer to) annotation 156. This adjustment may be repeated until the output error for a given training sample data 401 satisfies a predetermined condition (e.g., falls below a predetermined value). Subsequently, a different training sample data 401 may be selected, a new training prediction 164 generated for the training sample data 401, and a new series of adjustments implemented, until the respective neural networks are trained to an acceptable degree of accuracy or until the networks reach their architecture-limited accuracy. In some embodiments, multiple networks may be trained end-to-end, e.g., with backbone network, differentiator network, aggregator (if implemented as a neural network), differentiator networks 331-33N, aggregator (if implemented via a neural network), and/or classification head 370 trained together, e.g., using concurrent error backpropagation through various layers of the networks.

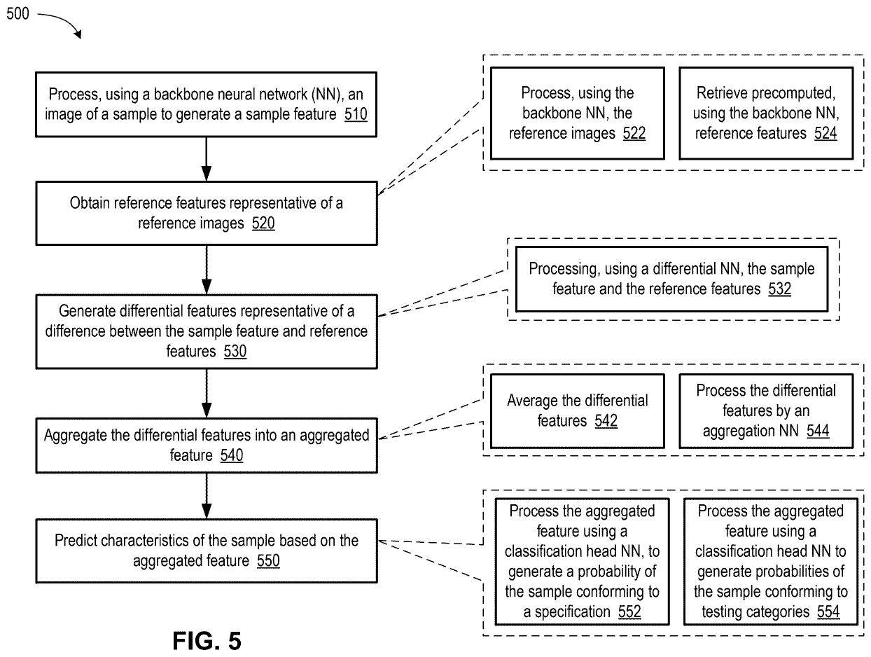

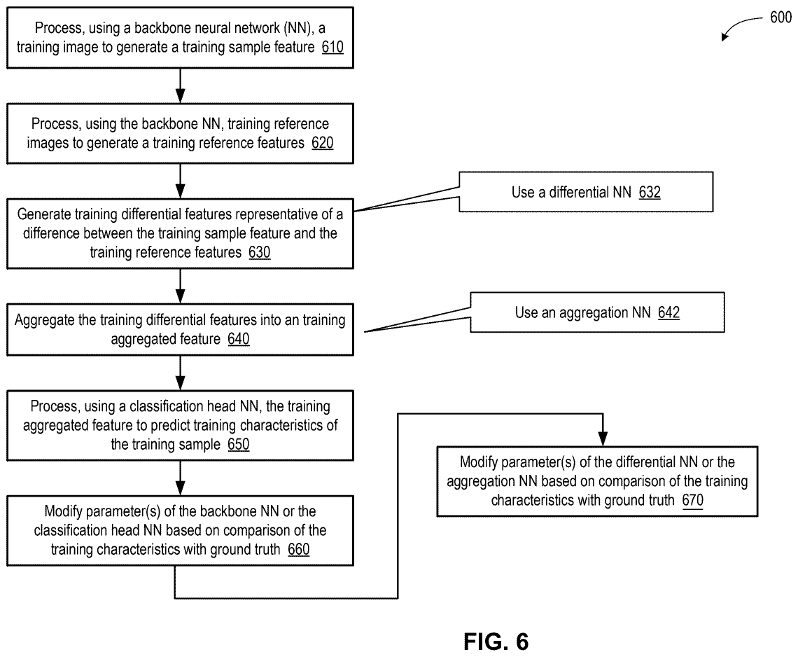

FIG. 5 and FIG. 6 illustrate example methods 500 and 600 of training and deployment of a multi-golden sample inspection system, according to some embodiments of the present disclosure. Methods illustrated in FIG. 5 and/or FIG. 6 may be used in the context of performing quality inspections of manufacturing products, in one embodiment. Methods 500 and/or 600 may be performed by one or more processing units (e.g., CPUs and/or GPUs), which may include (or communicate with) one or more memory devices. In at least one embodiment, method 500 and/or method 600 may be performed by multiple processing threads (e.g., CPU threads and/or GPU threads), each thread executing one or more individual functions, routines, subroutines, or operations of the method. In at least one embodiment, processing threads implementing method 500 and/or method 600 may be synchronized (e.g., using semaphores, critical sections, and/or other thread synchronization mechanisms). Alternatively, processing threads implementing method 500 and/or 600 may be executed asynchronously with respect to each other. Various operations of methods 500 and/or 600 may be performed in a different order compared with the order shown in FIG. 5 and/or FIG. 6. Some operations of FIG. 5 and/or FIG. 6 may be performed concurrently with other operations. In at least one embodiment, one or more operations shown in FIG. 5 and/or FIG. 6 may not always be performed.

FIG. 5 is a flow diagram of an example method 500 of deployment of a multi-golden sample inspection system for inference of sample data, according to at least one embodiment. Method 500 may be performed by one or more processing units of computing device 102 of FIG. 1 or computing device 200 of FIG. 2. At block 510, processing units performing method 500 may process, using a backbone neural network (e.g., backbone network 310 in FIG. 3A), an image of a sample (e.g., sample data 301 in FIG. 3A) to generate a sample feature (e.g., sample feature 320 in FIG. 3A) representative of the sample. In some embodiments, the backbone neural network may include a convolutional neural network, a transformer neural network, a vision transformer neural network, and/or some other suitable neural network.

At block 520, method 500 may continue with obtaining a plurality of reference features, each reference feature of the plurality of reference features (e.g., reference features 321 . . . 32N in FIG. 3A) representative of a respective reference image of a plurality of reference images. In some embodiments, obtaining a respective reference feature of the plurality of reference features may include operations illustrated with callout blocks 522 and/or 524. More specifically, at block 522, method 500 may include processing, using the backbone neural network (e.g., one of backbone networks 311 . . . 31N in FIG. 3A), the respective reference image. At block 524, method 500 may include retrieving, from a memory device (e.g., memory 104 of computing device 102 or data store 150 in FIG. 1), the plurality of reference features previously generated (e.g., precomputed) by processing, using the backbone neural network, the plurality of reference images.

At block 530, method 500 may continue with generating a plurality of differential features (e.g., differential features 341 . . . 34N in FIG. 3A), each differential feature of the plurality of differential features representative of a respective difference between the sample feature and a respective reference feature of the plurality of reference features. In some embodiments, generating the plurality of differential features may include operations of the callout block 532, including processing, using a differential neural network (e.g., one of differentiator networks 331 . . . 33N in FIG. 3A), an input that includes the sample feature (e.g., sample feature 320) and the respective reference feature (e.g., one of reference features 321 . . . 32N in FIG. 3A).

At block 540, method 500 may include aggregating the plurality of differential features into an aggregated feature (e.g., aggregated feature 360 in FIG. 3A). In some embodiments, aggregating the plurality of reference features may include operations illustrated with the callout blocks 542 and/or 544. More specifically, at block 542, aggregating the plurality of reference features may include averaging the plurality of differential features to obtain the aggregated feature. In some embodiments, at block 544, aggregating the plurality of reference features may include processing the plurality of differential features by an aggregation neural network. In some embodiments, the aggregation neural network may include one or more fully-connected neuron layers, one or more attention blocks of neurons, and/or other suitable combinations of neurons.

At block 550, method 500 may continue with predicting one or more characteristics of the sample based on the aggregated feature. In some embodiments, predicting the one or more characteristics of the sample may include operations illustrated with the callout blocks 552 and/or 554. More specifically, at block 552 operations of method 500 may include processing, using a classification head neural network (e.g., classification head 370), the aggregated feature to generate a probability of the sample conforming to a specification of a sample manufacturing process. In some embodiments, predicting the one or more characteristics of the sample may include, at block 554, processing, using a classification head neural network, the aggregated feature to generate a plurality of probabilities, each probability of the plurality of probabilities representing a likelihood that the sample conforms to a corresponding testing category of a plurality of testing categories. The one or more characteristics of the sample may be integrated or otherwise incorporated into a manufacturing process. For example, these characteristics may be used to adjust one or more operations of a manufacturing system, ensuring that samples produced by the manufacturing system conform to applicable specifications.

FIG. 6 is a flow diagram of an example method 600 of training a multi-golden sample inspection system, according to at least one embodiment. Method 600 may be performed by one or more processing units of training server 160 illustrated in FIG. 1. At block 610, processing units performing method 600 may process, using the backbone neural network, a training image (e.g., training sample data 401 in FIG. 4) of a training sample to generate a training sample feature (e.g., training sample feature 420 in FIG. 4) representative of the training sample.

At block 620, method 600 may continue with processing, using the backbone neural network, a plurality of training reference images (e.g., training reference data 402-1 . . . 402-N in FIG. 4), to generate a plurality of corresponding training reference features (e.g., training reference features 421 . . . 42N in FIG. 4).

At block 630, method 600 may include generating a plurality of training differential features (e.g., training differential features 441 . . . 44N in FIG. 4), each training differential feature of the plurality of training differential features representative of a respective difference between the training sample feature (e.g., training sample feature 420 in FIG. 4) and a respective training reference feature of the plurality of training reference features (e.g., training reference features 421 . . . 42N in FIG. 4). In some embodiments, as illustrated with the callout block 632, generating the plurality of training differential features may include using a differential neural network (e.g., one of differential networks 331 . . . 33N in FIG. 4).

At block 640, operation of method 600 may include aggregating the plurality of training differential features to obtain a training aggregated feature (e.g., training aggregated feature 460 in FIG. 4). In some embodiments, as illustrated with the callout block 642, aggregating the plurality of training differential features may include using the aggregation neural network (e.g., aggregator 340 in FIG. 4).

At block 650, method 600 may include processing, using a classification head neural network (e.g., classification head 370 in FIG. 4), the training aggregated feature to predict one or more training characteristics of the training sample.

At block 660, method 600 may continue with modifying one or more parameters of at least one of the backbone neural network or the classification head neural network based on a comparison of the one or more training characteristics of the training sample with a ground truth for the training sample (e.g., as illustrated with the dashed arrows in FIG. 4). In some embodiments, as illustrated with block 670, method 600 may further include modifying one or more parameters of at least one of the differential neural network or the aggregation neural network.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, analytics operations, factory operations, generation and/or presentation of augmented reality (AR), virtual reality (VR), mixed reality (MR), etc., robotics operations, medical operations, security and surveillance (e.g., in a smart cities embodiment), autonomous or semi-autonomous machine applications, deep learning, environment simulation, object or actor simulation and/or digital twinning, data center processing, generative AI operations, conversational AI operations, operations involving vision language models, large language models, multi-modal language models, light transport simulations (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), and in-vehicle infotainment system for an autonomous or semi-autonomous machine, systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Inference and Training Logic

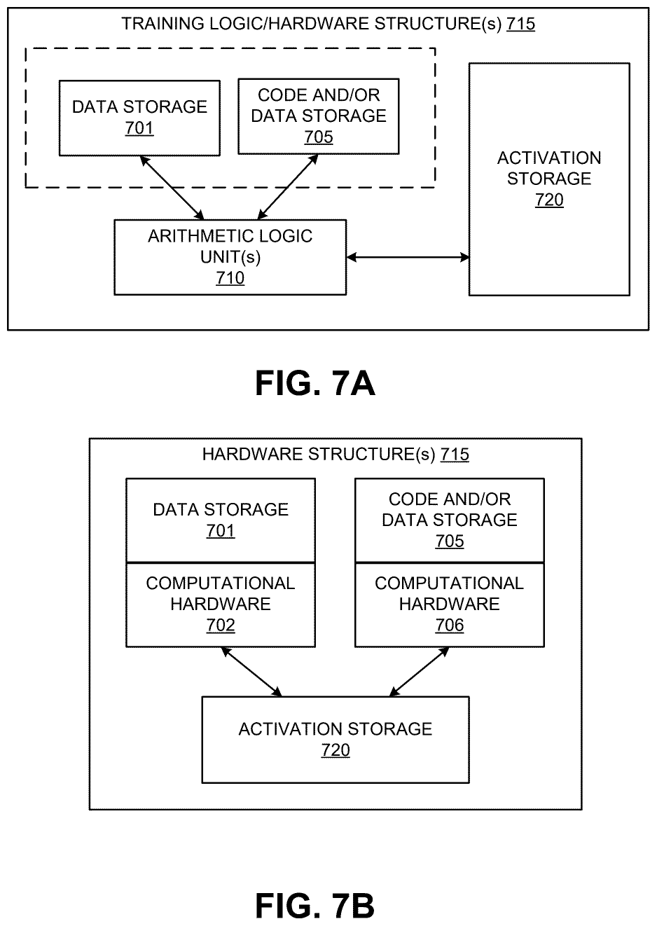

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710,including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

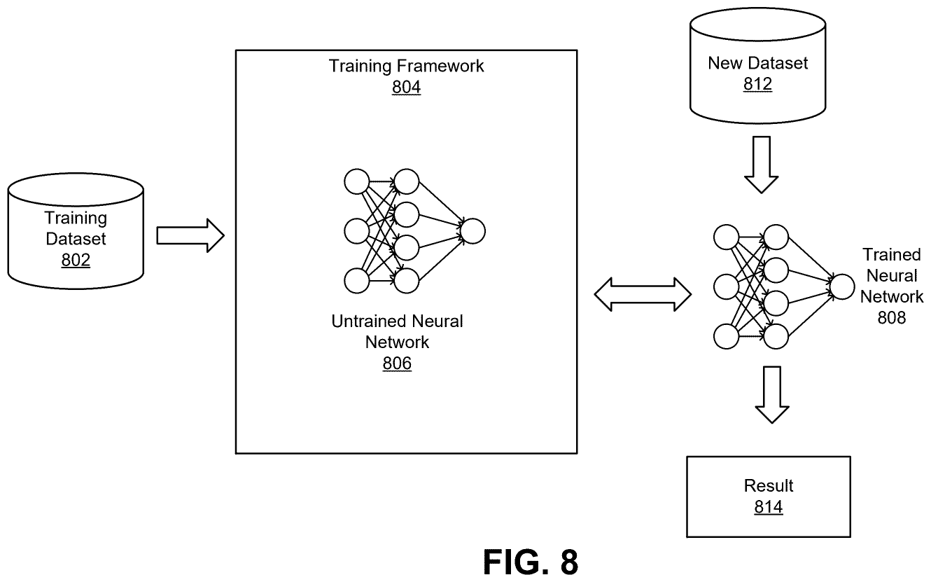

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812. In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

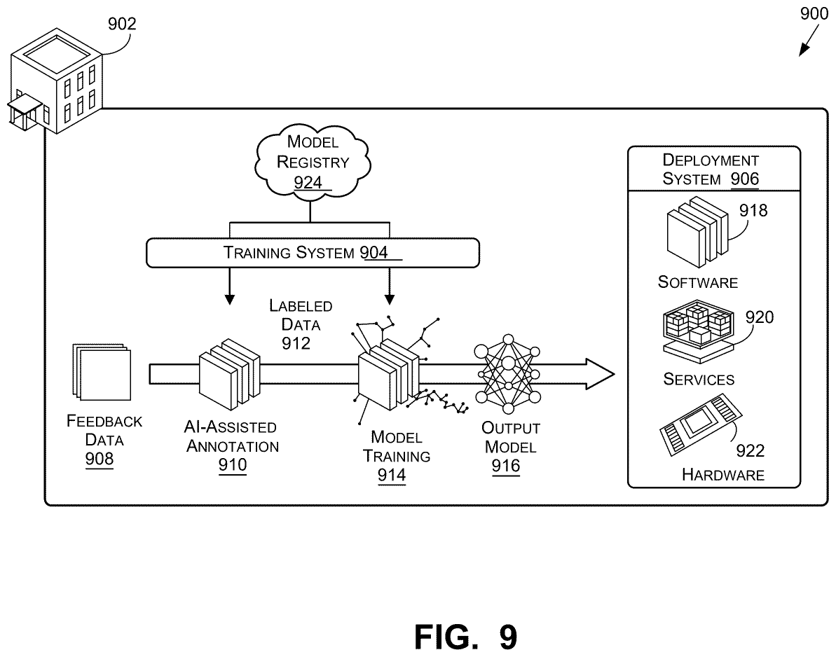

With reference to FIG. 9, FIG. 9 is an example data flow diagram for a process 900 of generating and deploying a processing and inferencing pipeline, according to at least one embodiment.. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

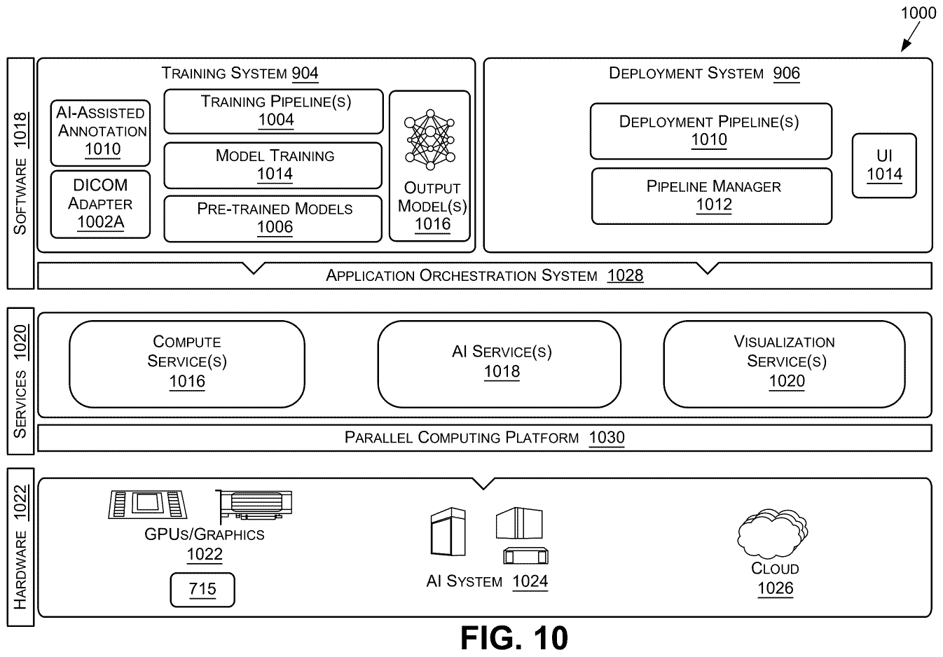

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018. In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
processing, using at least one backbone neural network (NN), an image of a sample to generate a sample feature representative of the sample;
obtaining a plurality of reference features, each reference feature of the plurality of reference features representative of a respective reference image of a plurality of reference images;
generating a plurality of differential features, each differential feature of the plurality of differential features representative of a respective difference between the sample feature and a respective reference feature of the plurality of reference features;
predicting one or more characteristics of the sample based on an aggregated feature obtained by aggregating the plurality of differential features; and
using the one or more characteristics to adjust one or more operations of a manufacturing process.

2. The method of claim 1, wherein obtaining the plurality of reference features comprises:
processing, using the at least one backbone NN, the plurality of reference images.

3. The method of claim 1, wherein obtaining the plurality of reference features comprises:
retrieving, from a memory device, the plurality of reference features previously generated by processing, using the at least one backbone NN, the plurality of reference images.

4. The method of claim 1, wherein generating the plurality of differential features comprises:
processing, using at least one differential NN, an input comprising the sample feature and the respective reference feature.

5. The method of claim 1, wherein predicting the one or more characteristics of the sample comprises:
processing, using a classification head NN, the aggregated feature to generate a probability of the sample conforming to a specification of the manufacturing process.

6. The method of claim 1, wherein predicting the one or more characteristics of the sample comprises:
processing, using a classification head NN, the aggregated feature to generate a plurality of probabilities, each probability of the plurality of probabilities representing a likelihood that the sample conforms to a corresponding testing category of a plurality of testing categories.

7. The method of claim 1, wherein the at least one backbone NN comprises at least one of:
a convolutional NN,
a transformer NN, or
a vision transformer NN.

8. The method of claim 1, wherein aggregating the plurality of reference features comprises:
averaging the plurality of differential features to obtain the aggregated feature.

9. The method of claim 1, wherein aggregation of the plurality of reference features comprises:
processing the plurality of differential features by an aggregation NN.

10. The method of claim 9, wherein the aggregation NN comprises at least one of:
one or more fully-connected neuron layers, or
one or more attention blocks of neurons.

11. The method of claim 9, wherein the at least one backbone NN is updated using operations comprising:
processing, using the at least one backbone NN, a training image of a training sample to generate a training sample feature representative of the training sample;
processing, using the at least one backbone NN, a plurality of training reference images, to generate a plurality of corresponding training reference features;
generating a plurality of training differential features, each training differential feature of the plurality of training differential features representative of a respective difference between the training sample feature and a respective training reference feature of the plurality of training reference features;
aggregating the plurality of training differential features to obtain a training aggregated feature;
processing, using a classification head NN, the training aggregated feature to predict one or more training characteristics of the training sample; and
modifying one or more parameters of at least one of the at least one backbone NN or the classification head NN based on a comparison of the one or more training characteristics of the training sample with a ground truth for the training sample.

12. The method of claim 11, wherein generating the plurality of training differential features comprises using at least one differential NN, and wherein aggregating the plurality of training differential features comprises using the aggregation NN, the method further comprising:
modifying one or more parameters of at least one of the at least one differential NN or the at least one aggregation NN.

13. A system comprising:
a memory device; and
one or more processing devices, communicatively coupled to the memory device, to:
process, using at least one backbone neural network (NN), an image of a sample to generate a sample feature representative of the sample;
obtain a plurality of reference features representative of a plurality of reference images associated with acceptable tolerances of a manufacturing process;
generate a plurality of differential features, each differential feature of the plurality of differential features representative of a respective difference between the sample feature and a respective reference feature of the plurality of reference features; and
integrate one or more characteristics of the sample into the manufacturing process, the one or more characteristics predicted based on the plurality of differential features.

14. The system of claim 13, wherein to obtain the plurality of reference features, the one or more processing devices are to perform at least one of:
process, using the at least one backbone NN, the plurality of reference images; or
retrieve, from the memory device, the plurality of reference features previously generated by processing, using the at least one backbone NN, the plurality of reference images.

15. The system of claim 13, wherein to generate the plurality of differential features, the one or more processing devices are to:
process, using at least one differential NN, an input comprising the sample feature and the respective reference feature.

16. The system of claim 13, wherein to predict the one or more characteristics of the sample, the one or more processing devices are to perform at least one of:
process, using a classification head NN, the plurality of differential features to generate a probability of the sample conforming to a specification of the manufacturing process; or
process, using a classification head NN, the plurality of differential features to generate a plurality of probabilities, each probability of the plurality of probabilities representing a likelihood that the sample conforms to a corresponding testing category of a plurality of testing categories.

17. The system of claim 13, wherein to aggregate the plurality of reference features, the one or more processing devices are to perform at least one of:
average the plurality of differential features to obtain the aggregated feature; or
process the plurality of differential features by an aggregation NN.

18. The system of claim 13, wherein the at least one backbone NN comprises at least one of:
a convolutional NN,
a transformer NN, or
vision transformer NN.

19. The system of claim 13, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing one or more medical operations;
a system for performing one or more factory operations;
a system for performing one or more analytics operations;
a system implementing one or more inference microservices;
a system for performing light transport simulations;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more small language models (SLMs);
a system implementing one or more vision language models (VLMs);
a system implementing one or more multi-modal language models;
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

20. One or more processors comprising:
processing circuitry to perform a first stage of neural network operations that represent an image of a manufacturing product and multiple reference images via respective image features and a second stage of neural network operation that jointly processes the image features to identify a degree of compliance of the manufacturing product with a specification for the manufacturing product.
